(19) United States
(12) Patent Application Publication
(10) Pub. No.: US 2010/0174792 A1
(43) Pub. Date: Jul. 8, 2010

(54) GROUP FORMING SYSTEM

(75) Inventor: Yuuko Takei, Tokyo (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/602,085

(22) PCT Filed: May 29, 2007
(86) PCT No.: PCT/JP2007/060907

§ 371 Date: Nov. 25, 2009

(51) Int. Cl. G06F 15/16

(52) U.S. Cl. 709/206; 709/204

(57) ABSTRACT

Each of client terminals stores a history of users of the other client terminals invited to a predetermined group, and the history has the identification information of the group, topic information of the group and the identification information of the users invited to the group so as to be associated with each other. In a group forming system, the first client terminal of a user who desires restoration of a deleted group transmits an invitation request, which includes topic information of the deleted group, identification information of the deleted group and identification information of the users invited to the deleted group, to the client terminals of the users invited to the deleted group. In a case where the history stored in the terminal includes the same topic information as the topic information indicated in the invitation request and includes the corresponding group of the same identification information as the identification information of the group indicated in the invitation request, the second client terminal that has received the invitation request transmits the invitation request to users, who are not included in the invited users indicated in the invitation request, among the users invited to the corresponding group by the terminal.

### TECHNICAL FIELD

The present invention relates to a group forming system for grouping a plurality of communication terminals that can communicate with each other via a network.

### BACKGROUND ART

In a system to support the IMPS (Instant Messaging and Presence Service) and PoC (Push to Talk Over Cellular), the specifications of which are opened to the public by the OMA (Open Mobile Alliance) that is the industry association of mobile communications, it is possible to group a plurality of communication terminals. For example, after a user of a specified communication terminal transmits identification information of a user to be invited to a specified group and an invitation request to the group to a server that is in charge of controlling groups, a group consisting of at least these two users as members is formed upon a predetermined procedure by the invited users. However, according to the group forming method, it is necessary that the communication terminal of a user at the inviting side holds the identification information of a user at the invited side in advance, and it is also necessary that the user at the inviting side designates a user at the invited side by manual operations.

Patent Documents 1 through 3 disclose arts in which improvements were added to these points. According to the art disclosed in Patent Document 1, hobbies and tastes of respective users are registered in advance, a server extracts terminals of users who have a specified hobby and taste or extracts terminals corresponding to a specified condition, and the server notifies a group address of a generated group to the terminals thus extracted. According to the art disclosed in Patent Document 2, a server carries out matching of users or groups, in which the users participate, to the existing groups, and extends the groups. According to the art disclosed in Patent Document 3, a retrieval request of topics is transmitted to a node, the node and the other nodes to which the retrieval request is transferred from the node compare the obtained retrieval request with the topics list of respective nodes and return the result of comparison, thereby forming a community among a plurality of nodes.

According to the arts disclosed in Patent Documents 1 through 3 described above, without any necessity to hold identification information of a user at the invited side and information of hobbies and tastes, etc., in the terminal of the user at the inviting side, it is possible to invite users, the conditions of which are satisfactory, to a group. In addition, a user at the inviting side is not required to designate the users, who satisfy the conditions, by manual operations.

Patent Document 1: JP-A-2003-134161

Patent Document 2: JP-A-2005-284495

Patent Document 3: JP-A-2006-236344

Patent Document 4: JP-A-2005-354294

Patent Document 5: JP-A-2005-312045

Patent Document 6: JP-A-2004-054340

Patent Document 7: JP-A-2005-277806

### DISCLOSURE OF THE INVENTION

### Problems to be Solved by the Invention

According to IMPS, users are capable of freely preparing and managing a private group, and with respect to the corresponding private group, a user having an access right over a predetermined level is given the authority to prepare, delete and manage the private group. Thus, the specification is not that the authority to delete the private group is given only to a specified user. Therefore, there may be cases where a user would delete the private group, although the members who join the group do not agree with the deletion thereof. In addition, a public group regulated in the IMPS is prepared and managed by a service provider, wherein any user is not given the authority to prepare, delete and manage the public group.

In the arts described above, it is impossible to restore a part or the entirety of the group thus deleted. For example, in the art of Patent Document 1, hobbies and tastes of respective users are registered as a part of user information that can be opened to the public, and a group in which some of the users who satisfy the conditions are made into members is formed. Accordingly, in the corresponding art, since the information relating to the members is also deleted when the group is deleted, it is impossible to restore the group with the members limited to the users belonging to the deleted group or reliable users.

Further, in the art in Patent Document 1, with respect to new preparation and extension of groups, it is necessary for a server to retrieve users that are coincident with a specified condition concerning the group subjected to new preparation or extension. For this reason, the server is required to have a user retrieval function, and is subjected to load required for the retrieval. In addition, in the arts in Patent Documents 2 and 3, except in cases where a user already participates in an existing group with respect to the hobbies and tastes of the user, it is not possible to newly prepare or extend the group relating to a specified condition. Further, since it is necessary to provide respective nodes with a retrieval function even in a case where the user participates in the existing group, the nodes are subjected to load for retrieval.

Thus, in the arts of Patent Documents 1 through 3, it is not possible to easily carry out restoration of a deleted group and formation of groups including new preparation or extension thereof.

It is therefore an object of the present invention to provide a group forming system capable of simply forming groups.

### Means for Solving the Problem

According to the present invention, there is provided a group forming system for forming a group of at least a part of a plurality of client terminals which carry out communications via a network, wherein: each of the client terminals stores a history of users or groups of other client terminals invited to a predetermined group, and the history has, group by group, identification information of the predetermined group, topic information of the predetermined group and identification information of the users or groups invited to the predetermined group so as to be associated with each other; a first client terminal of a user that desires restoration of a deleted group when restoring at least a part of the deleted group transmits an invitation request including topic information of the deleted group and identification information of the deleted group to the client terminal of users or groups invited to the deleted group by the first client terminal; and in a case where the same topic information as the topic information indicated in the invitation request is included, and a corresponding group of the same identification information as the identification information of the group indicated in the invitation request is included, in the history stored in a second client terminal that has received the invitation request, the second client terminal transmits the invitation request to users or groups, which are not included in the invited users or groups indicated in the invitation request, among users or groups invited by the second client terminal to the corresponding group.

In the group forming system, the invitation request includes identification information of the users or groups invited by the first client terminal to the deleted group.

In the group forming system, the second client terminal adds identification information of a user or a group, which is not included in the users or groups indicated in the invitation request transmitted by the first client terminal, among users or groups invited by the second client terminal to the corresponding group, to the identification information of users or groups indicated in the invitation request which is to be transmitted by the second client terminal.

In the group forming system, the invitation request includes a value showing the number of transferable times of the invitation request transmitted between the client terminals, and the respective client terminals decrement the value one by one whenever the invitation request is transmitted to other client terminals.

In the group forming system, the invitation request includes information to instruct to retrieve whether the history stored in the client terminal which has received the invitation request includes the same topic information as the topic information indicated in the invitation request.

In the group forming system, the client terminal transmits the information included in the invitation request in the form of a message.

According to the present invention, there is provided a group forming system for forming a group of at least a part of a plurality of client terminals which carry out communications via a network, wherein: each of the client terminals stores a history of users or groups of other client terminals invited to a predetermined group, and the history has, group by group, identification information of the predetermined group, topic information of the predetermined group and identification information of the users or groups invited to the predetermined group so as to be associated with each other; when extending a group related to specified information, a first client terminal of a user that desires extension of the group transmits an invitation request including topic information relating to the specified information and identification information of the group to be extended to client terminals of users or groups included in the history stored in the first client terminal and corresponding to the specified topic; and in a case where corresponding topic information at least partially including the topic information indicated in the invitation request is included in the history stored in a second client terminal that has received the invitation request, the second client terminal transmits the invitation request to corresponding groups excluding the groups having the same identification information as the identification information of the group to be extended indicated in the invitation request among the groups corresponding to the corresponding topic information, the corresponding group not included in the invited groups indicated in the invitation request.

In the group forming system, the invitation request includes identification information of users or groups invited to the group corresponding to the topic information.

In the group forming system, the second client terminal adds identification information of the corresponding group to the invitation request to be transmitted by the second client terminal.

In the group forming system, the invitation request has a value showing the number of transferable times of the invitation request transmitted between the client terminals, and the respective client terminals decrement the value one by one whenever the invitation request is transmitted to other client terminals.

In the group forming system, the invitation request includes information to instruct to retrieve for whether the corresponding topic information at least partially including the topic information indicated in the invitation request, in the history stored in the client terminal that has received the invitation request.

In the group forming system, the client terminal transmits the information indicated in the invitation request in the form of a message.

According to the present invention, there is provided a group forming system for forming a group of at least a part of a plurality of client terminals which carry out communications via a network, wherein: each of the client terminals stores a history of users or groups of other client terminals invited to a predetermined group, and the history has, group by group, identification information of the predetermined group, topic information of the predetermined group and identification information of the users or groups invited to the predetermined group so as to be associated with each other; when newly preparing a group related to specified information, a first client terminal of a user that desires new preparation of the group transmits an invitation request including topic information relating to the specified information and identification information of the newly preparing group to client terminals of users or groups included in the history stored in the first client terminal and corresponding to the specified topic; and in a case where corresponding topic information at least partially including the topic information indicated in the invitation request is included in the history stored in a second client terminal that has received the invitation request, the second client terminal transmits the invitation request to corresponding user of corresponding groups excluding the groups having the same identification information as the identification information of the newly preparing group indicated in the invitation request among the groups corresponding to the corresponding topic information, the corresponding group not included in the invited groups indicated in the invitation request.

According to the present invention, there is provided a client terminal used in a group forming system for forming a group of at least a part of a plurality of client terminals which carry out communications via a network, wherein: the client terminal stores a history of users or groups of other client terminals invited to a predetermined group, and the history has, group by group, identification information of the predetermined group, topic information of the predetermined group and identification information of the users and groups invited to the predetermined group so as to be associated with each other; when restoring at least a part of a deleted group, the client terminal transmits an invitation request including topic information of the deleted group and identification information of the deleted group to client terminals of users or groups invited to the deleted group; and when the client terminal receives an invitation request from another client terminal, in a case where the history includes the same topic information as the topic information indicated in the invitation request and a corresponding group of the same identification information as the identification information of the group indicated in the invitation request, the client terminal transmits the invitation request to client terminals of users or groups, which are not included in the invited users or groups indicated in the invitation request, among the users or groups invited to the corresponding group by the client terminal.

In the client terminal, the invitation request includes identification information of the users or groups invited by the client terminal to the deleted group.

In the client terminal, the client terminal adds identification information of a user or a group, which is not included in the users or groups indicated in the invitation request transmitted by the other client terminal, among users or groups invited to the corresponding group, to the identification information of users or groups indicated in the invitation request which is to be transmitted by the client terminal

In the client terminal, the invitation request includes a value showing the number of transferable times of the invitation request transmitted between the client terminals, and the client terminal decrement the value one by one whenever the invitation request is transmitted to other client terminals.

In the client terminal, the invitation request includes information to instruct to retrieve for whether the history stored in the client terminal which has received the invitation request includes the same topic information as the topic information indicated in the invitation request.

In the client terminal, the client terminal transmits the information included in the invitation request in the form of a message.

According to the present invention, there is provided a client terminal used in a group forming system for forming a group of at least a part of a plurality of client terminals which carry out communications via a network, wherein: the client terminal stores a history of users or groups of other client terminals invited to a predetermined group, and the history has, group by group, identification information of the predetermined group, topic information of the predetermined group and identification information of the users and groups invited to the predetermined group so as to be associated with each other; when extending a group related to specified information, the client terminal transmits an invitation request including topic information relating to the specified information and identification information of a group to be extended to client terminals of users or groups included in the history stored in the client terminal and corresponding to the specified topic; and when receiving an invitation request from another client terminal, in a case where corresponding topic information at least partially including the topic information indicated in the invitation request is included in the history, the client terminal transmits the invitation request to corresponding groups excluding the groups having the same identification information as the identification information of the group to be extended indicated in the invitation request in the groups corresponding to the corresponding topic information, the corresponding group not included in the invited groups indicated in the invitation request.

In the client terminal, the invitation request includes identification information of users or groups invited to the group corresponding to the topic information.

In the client terminal, the client terminal adds identification information of the corresponding group to the invitation request to be transmitted by the client terminal.

In the client terminal, the invitation request has a value showing the number of transferable times of the invitation request transmitted between the client terminals; and the client terminal decrements the value one by one whenever the client terminal transmits the invitation request to the other client terminals.

In the client terminal, the invitation request includes information to instruct to retrieve for whether the topic information at least partially having the topic information indicated in the invitation request is included in the history stored in the client terminal that has received the invitation request.

In the client terminal, the client terminal transmits the information included in the invitation request in the form of a message.

According to the present invention, there is provided a client terminal used in a group forming system for forming a group of at least a part of a plurality of client terminals which carry out communications via a network, wherein: the client terminal stores a history of users or groups of other client terminals invited to a predetermined group, and the history has, group by group, identification information of the predetermined group, topic information of the predetermined group and identification information of users and groups invited to the predetermined group so as to be associated with each other; when newly preparing a group related to specified information, the client terminal transmits an invitation request including topic information relating to the specified information and identification information of the newly prepared group to client terminals of users or groups included in the history stored in the client terminal and corresponding to the specified topic; and when receiving an invitation request from another client terminal, in a case where corresponding topic information at least partially including the topic information indicated in the invitation request is included in the history, the client terminal transmits the invitation request to corresponding user of corresponding groups excluding the groups having the same identification information as the identification information of the newly preparing group indicated in the invitation request among the groups corresponding to the corresponding topic information, the corresponding group not included in the invited groups indicated in the invitation request.

### Advantageous Effects of the Invention

According to the group forming system of the present invention, restoration of a deleted group and formation of groups including new preparation and extension thereof can easily be carried out.

### BRIEF DESCRIPTION OF THE DRAWINGS

FIG. 1 shows the concept of group formation by the IMPS system according to a first embodiment of the present invention;

FIG. 2 is a diagram showing a sequence by a group forming system according to the first embodiment of the present invention;

FIG. 3 is a flowchart showing an Invite-Request transfer process carried out by the group forming system according to the first embodiment of the present invention;

FIG. 4 is a flowchart showing an Invite-Request transfer process carried out by the group forming system according to the first embodiment of the present invention;

FIG. 5 is a flowchart showing an Invite-Request transfer process carried out by the group forming system according to the first embodiment of the present invention;

FIG. 6 shows data registered in an information table 110 stored by a client terminal 101 described in FIG. 1;

FIG. 7 shows data registered in an information table stored by a client terminal 102 described in FIG. 1;

FIG. 8 shows XML data of CreateGroup-Request 211 including Group ID of a group newly prepared for restoration of a group and a Topic of the deleted group 111;

FIG. 9 shows XML data of Invite-Request 221 in a case where a group is restored;

FIG. 10 shows XML data of InviteUser-Request 223 in a case where a group is restored;

FIG. 11 shows XML data of Invite-Request 231 in a case where a group is restored;

FIG. 12 shows XML data of InviteUser-Request 233 in a case where a group is restored;

FIG. 13 shows XML data of Invite-Request 221 that the client terminal 101 transmits to the IMPS server 114 where extending a group;

FIG. 14 shows XML data of InviteUser-Request 223 that the IMPS server 114 which has received Invite-Request 221 transmits to a client terminal 102 where extending a group;

FIG. 15 shows XML data of the Invite-Request 231 that has passed through Step S410 and is generated in Steps S412 and S413; and

FIG. 16 shows XML data of SendMessage-Request that the client terminal 102 transmits to the IMPS server 114 in the IMPS system shown in FIG. 1.

### DESCRIPTION OF REFERENCE NUMERALS AND SIGNS

101 through 109 Client terminals
114 IMPS server

### BEST MODE FOR CARRYING OUT THE INVENTION

Hereinafter, a description is given of the embodiments of the present invention with reference to the drawings. Also, in the embodiments described below, a description is given of a group forming system as an IMPS system that supports IMPS V1.2.1 the specification of which is opened to the public by the OMA.

### First Embodiment

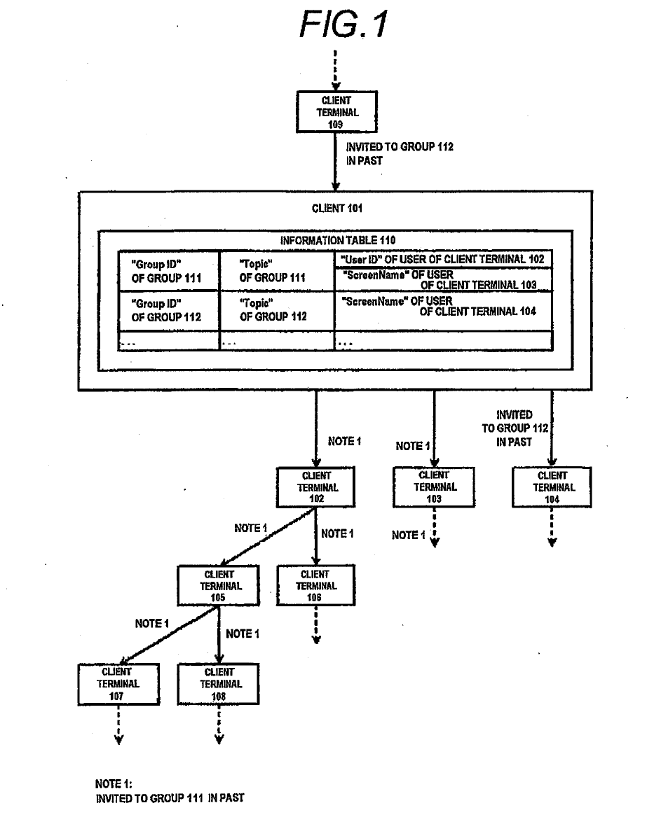

FIG. 1 shows the concept of group formation by a group forming system according to a first embodiment of the present invention. As shown in FIG. 1, the group forming system includes a plurality of client terminals 101 through 109 that communicate with each other via a network. Each of the client terminals stores an information table showing an invitation history. The information table registers [GroupID] being identification information of respective groups designated as invitation addresses, [Topic] being topic information of the respective groups, and [UserID] or [ScreenName] being identification information of a user who has been invited to the respective groups, or [GroupID] of a group that has been invited to respective groups. Also, the respective User IDs, Screen names or Group IDs are associated with the Group ID and Topic of an invited group. Further, the identification information of the user and group registered in the information table may be identification information of a user who has participated in a group or the group.

In addition, Group ID, Topic, User ID and ScreenName are the names of the information defined in the specification related to the IMPS of the OMA. Also, the ScreenName is a user name used for group conversation and is composed of a combination of a Group ID and Sname corresponding to a display name on a display. Further, the topic information of a group may be another name information other than the Topic. In addition, the Group ID, User ID, and ScreenName may be another name information if they are identification information of a group, identification information of a user and user name used in group conversation. Further, the identification information of a user may be made into a transmission source included in a message received in the group conversation.

In the example shown in FIG. 1, the user of client terminal 101 has been invited to a group 111 by the user of client terminal 109, has invited the respective users of client terminals 102 and 103 to the group 111, and has invited the user of client terminal 104 to the group 112 in the past. Therefore, in the information table 110 stored in the client terminal 101, respective Group IDs of the groups 111 and 112, respective Topic of the groups 111 and 112, user ID of the user of the client terminal 102 invited to the group 111 and ScreenName of the user of the client terminal 103, and ScreenName of the user of the client terminal 104 invited to the group 112 are registered. Also, the User ID of the user of the client terminal 102 and the ScreenName of the user of the client terminal 103 are associated with the. Group ID and Topic of the group 111, and the ScreenName of the user of the client terminal 104 is associated with the Group ID and Topic of the group 112.

Further, in the example shown in FIG. 1, the user of the client terminal 102 has been invited to the group 111 by the user of the client terminal 101, and has invited respective users of the client terminals 105 and 106 to the group 111 in the past. Also, the user of the client terminal 105 has been invited to the group 111 by the user of the client terminal 102 and has invited respective users of the client terminals 107 and 108 to the group 111 in the past. In addition, in the present embodiment, although information relating to the users invited to the groups is registered in the information table, the information table may register only the invited users.

In a state where the group configuration described above is formed, for example, if the user of the client terminal 110 deletes the group 111, all the users who participate in the group 111 will not be able to receive messages addressed to the group 111. If a specified group is deleted, the information of the members who participate in the group be deleted from the server. Accordingly, since users in the conventional system have no means to obtain information relating to the members other than the users registered in the information table of the client terminal, the users will not be able to restore the deleted group. However, in the group forming system according to the present embodiment described below, a group having a configuration approximate to the configuration of the deleted group can be formed. In addition, the group configuration shows an aggregate of members who participate in a group.

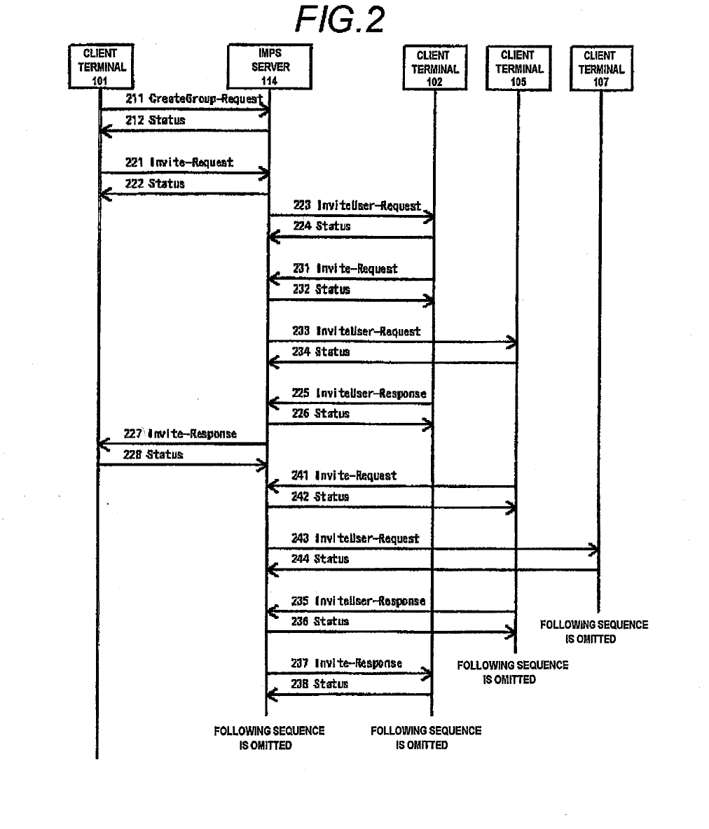

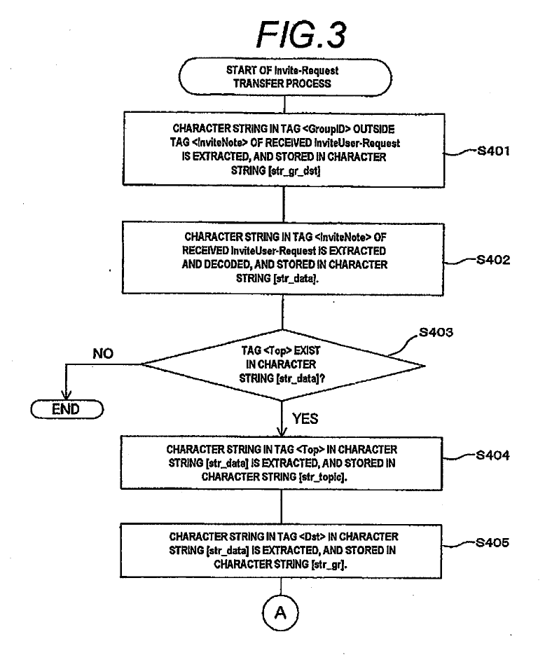

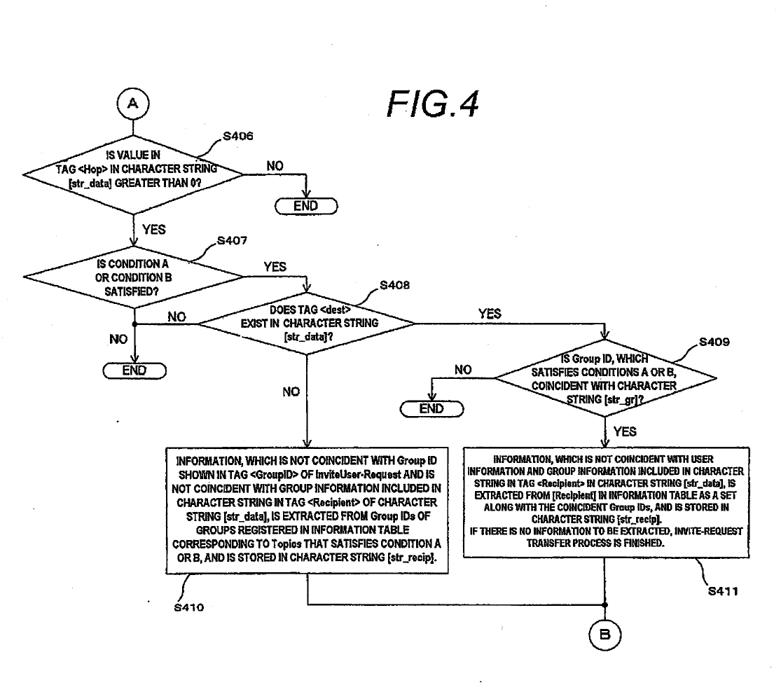

Hereinafter, a detailed description is given of a group forming system for restoring at least a part of the group 111 shown in FIG. 1 after the group 111 is deleted, with reference to the drawings. FIG. 2 shows a sequence by a group forming system according to the first embodiment of the present invention. FIG. 3 through FIG. 5 are flowcharts showing an Invite-Request transfer process carried out by the group forming system according to the first embodiment of the present invention.

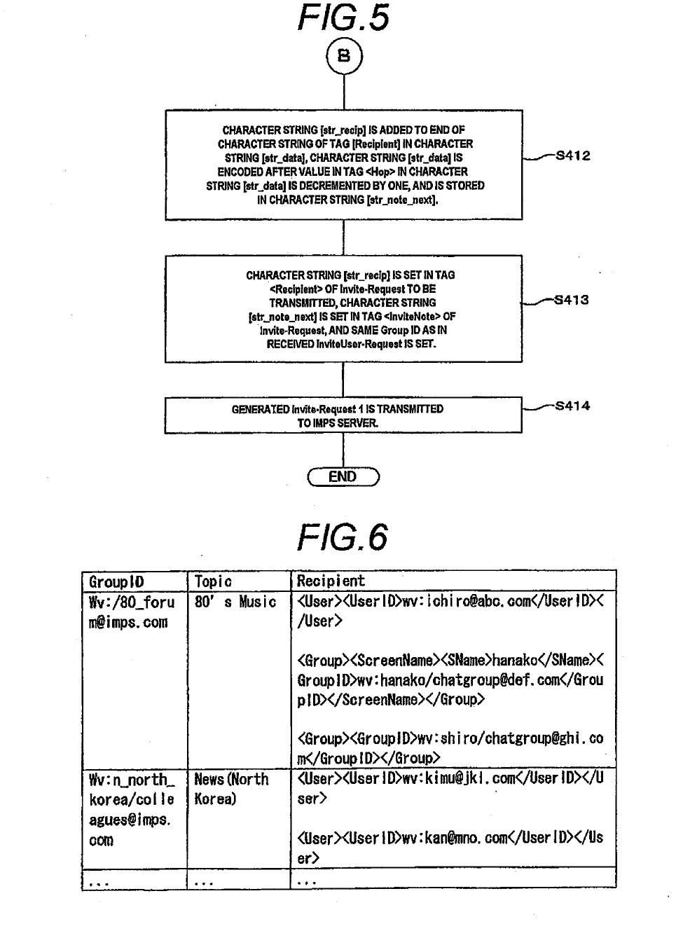

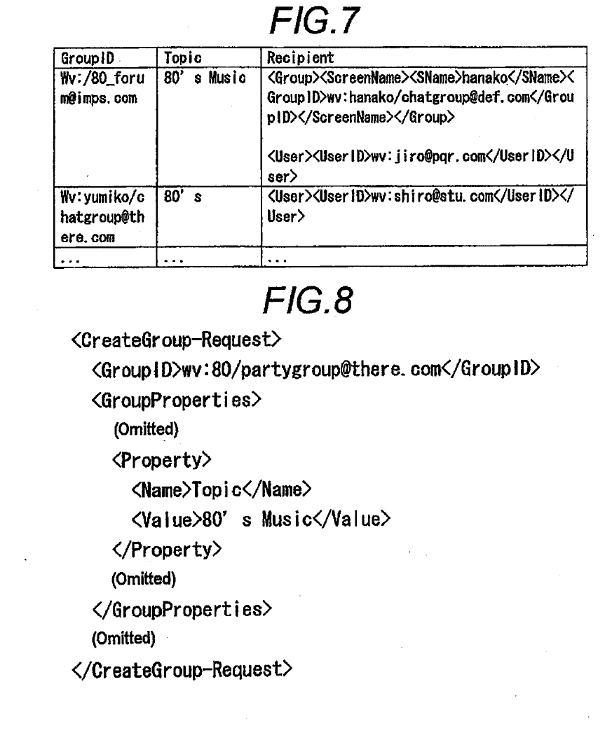

FIG. 6 shows data registered in the information table 110 stored in the client terminal 101 described in FIG. 1. FIG. 7 shows data registered in the information table stored in the client terminal 102 described in FIG. 1. In the information tables shown in FIG. 6 and FIG. 7, [GroupID] being the identification information of the group is described in the Group ID column, [Topic] being the topic information of the group is described in the Topic column, [UserID] and [ScreenName] being the identification information of users invited to the group and [GroupID] being the identification information of the group invited to the group are described in the Recipient column.

In the description below, assuming that the Group ID of the group 111 to be restored is made [wv:/80_forum@imps.com]. When the client terminal 101 instructs restoration of a part or the entirety of the group 111, as shown in FIG. 2, CreateGroup-Request 211 including the Group ID and Topic of the group 111 is transmitted from the client terminal 101 to the IMPS server 114. Also, the Group ID transmitted at this time may be a newly prepared ID or the Group ID of the group 111. FIG. 8 shows XML data of the CreateGroup-Request 211 including the Group ID of a newly prepared group for restoration of the group 111 and Topic of the deleted group 111. Further, when the CreateGroup-Request 211 shown in FIG. 8 is transmitted from the client terminal 101 to the IMPS server 114, the corresponding XML data is converted to the WBXML format defined by the OMA.

When the IMPS server 114 receives the CreateGroup-Request 211, the IMPS server 114 prepares a group based on the information in the

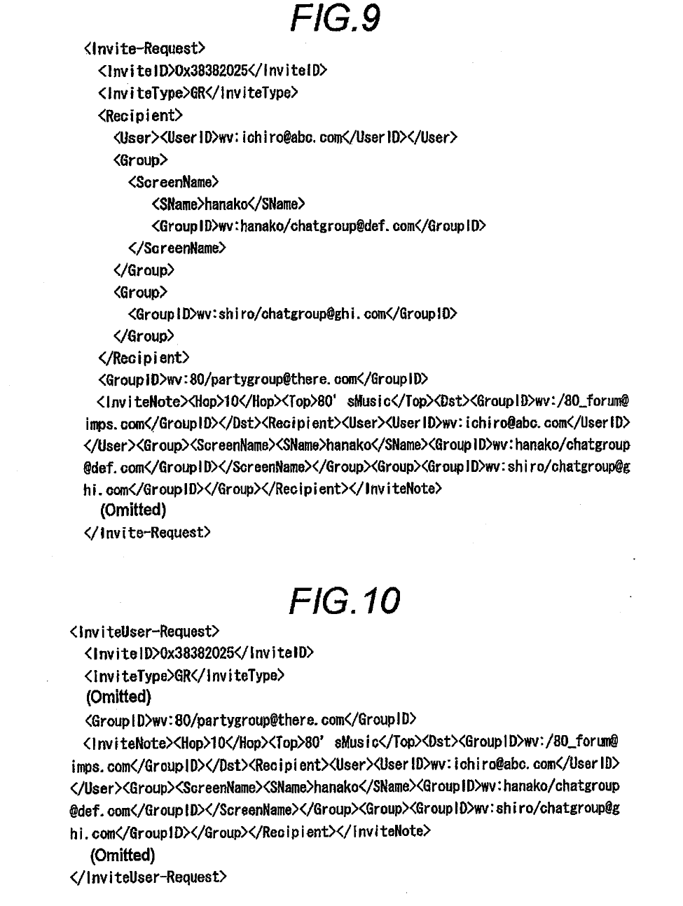

CreateGroup-Request 211, and transmits a status 212 including the result of preparation to the client terminal 111. The client terminal 101 transmits Invite-Request 221 to the IMPS server 114 if the information showing success of the group preparation is included in the received status 212. FIG. 9 shows XML data of the Invite-Request 221. As shown in FIG. 6, the Group ID (wv:/80_forum@imps.com) of the group 111, Topic (80's Music), user (wvichiro@abc.com, hanako) and group (wv:shiro/chatgroup@ghi.com) of the group 111 are registered in the information table 110 of the client terminal 101 so as to be associated with each other. The Invite-Request 221 shown in FIG. 9 invites these users and groups as members of the group in which “wv:80/partygroup@here.com” is prepared as the Group ID.

The character string between <Hop> and </Hop> in the <InviteNote> tag in the Invite-Request 221 shown in FIG. 9 shows the number of transfers of the Invite-Request 221, the character string between <Top> and </Top> shows a Topic of an inviting group, the character string between <Dst> and </Dst> shows a Group ID of the inviting group, and the character string between <Recipient> and </Recipient> shows information relating to persons who are to be invited.

When the IMPS server 114 receives an Invite-Request 221, the IMPS server 114 transmits a Status 222 to the client terminal 101, and transmits an InviteUser-Request to all the client terminals shown in the user information or the group information indicated in the tag <Recipient> in the Invite-Request 221. In the example shown in FIG. 1, the IMPS server 114 transmits an InviteUser-Request 223 to the client terminal 102. FIG. 10 shows XML data of the InviteUser-Request 223. The data in the tag <InviteNote> of the InviteUser-Request 223 is identical to the data in the tag <InviteNote> of the Invite-Request 221.

When the client terminal 102 receives the InviteUser-Request 223, the client terminal 102 transmits a Status 224 to the IMPS server 114. After that the transmission, the client terminal 102 carries out an Invite-Request transfer process shown in the flowcharts of FIG. 3 through FIG. 5. Hereinafter, referring to FIG. 3 through FIG. 5, a description is given of the Invite-Request transfer process carried out by the client terminal 102 that has received the InviteUser-Request 223. In Step S401, the client terminal 102 extracts a character string in the tag <GroupID> located outside the tag <InviteNote> of the received InviteUser-Request 223, and stores the character string in the character string [str_gr_dst]. The character string extracted in Step S401 is a Group ID of an inviting group, which is [wv:80/partygroup@there.com] in the example of the InviteUser-Request 223 shown in FIG. 10.

Next, in Step 5402, the client terminal 102 extracts and decodes a character string in the tag <InviteNote> of the InviteUser-Request 223, and stores the character string in the character string [str_data]. Next, in Step S403, the client terminal 102 checks whether the tag <Top> exists in the character string [str_data], wherein if the tag <Top> does not exist, the client terminal 102 finishes the Invite-Request transfer process, and if the tag <Top> does exist, the process advances to Step S404. Next, in Step S404, the client terminal 102 extracts a character string (80's Music) in the tag <Top> in the character string [str_data] and stores the character string in the character string [str topic]. Next, in Step S405, the client terminal 102 extracts a character string (<GroupID>wv:80/forum@imps.com</GroupID>) in the tag <Dst> in the character string [str_data], and stores it in the character string [str_gr].

Next, in Step S406, the client terminal 102 checks whether the value in the tag <Hop> in the character string [str_data] is greater than 0, wherein if it is 0 or less, the client terminal 102 finishes the Invite-Request transfer process, and if it is greater than 0, the process advances to Step S407. The value in the tag <Hop> shows the number of transferable times. In Step S407, the client terminal 102 checks whether the condition A or B is satisfied, wherein if both of the conditions are not satisfied, the client terminal 102 finishes the Invite-Request transfer process, and the process advances to Step S408 if any one of the conditions is satisfied.

The condition A is that the tag <Opt> does not exist in the character string [str_data] or the character in the tag <Opt> in the character string [str_data] is [A], and a Topic that is coincident with (completely coincident with) the character string [str_topic] (80's Music) stored in Step S404 exists in the information table of its own terminal. Also, the condition B is that the character in the tag <Opt> in the character string [str_data] is [I], and a Topic that includes (is partially coincident with) the character string [str_topic] (80's Music) exists in the information table of its own terminal. Thus, in Step S407, it is determined whether a group corresponding to a Topic that satisfies a retrieval condition shown by the tag <Opt> in the tag <InviteNote> of the received InviteUser-Request 223 is registered in the information table in the client terminal 102. Also, the Group ID of a group corresponding to the Topic coincident with the character string [str_topic] in the condition A or the Group ID of a group corresponding to the Topic including the character string [str_topic] in the condition B are referred to as [Retrieval result group ID] in the following description.

The tag <Opt> described above shows the retrieval method of Topics.

Where the character in the tag <Opt> is [A], retrieval is shown under the condition that is coincident with (completely coincident with) the designated character string, and the retrieval method is used for retrieval of a group for the purpose of restoration of a deleted group. On the other hand, where the character in the tag <Opt> is [I], retrieval is shown under the condition that includes (partially coincident with) the designated character string, and the retrieval method is used for retrieval of a group for the purpose of extension of the group. In addition, although complete coincidence or partial coincidence is made into the conditions in the present embodiment, a value showing such a condition as the coincidence ratio of a designated character string to the character string showing a Topic in the information table is more than a predetermined level may be indicated in the tag <Opt>. In this case, the substitute condition of the condition B in Step S407 is that a Topic whose coincidence ratio to the character string [str_topic] is more than a predetermined level exists in the information table of its own terminal.

In Step S408, the client terminal 102 checks whether the tag <dest> exists in the character string [str_data], wherein if it does exist, the process advances to Step S409, and if it does not exist, the process advances to Step 410. Thus, in Step 408, based on whether the tag <Dst> exists in the tag <InviteNote> of the received InviteUser-Request 223 after the condition A or the condition B is satisfied in Step S407, restoration of the deleted group (where the tag <Dst> does exist, after Step 409 or Step 411), or new preparation or extension of the group related to specified information (where the tag <Dst> does not exist, after Step S410 and Step S412) is determined.

In Step S409, the client terminal 102 checks whether the retrieval result group ID being the Group ID (wv:/80_forum@imps.com) of the group corresponding to the Topic that satisfies the condition A or the condition B is coincident with the character string [str_gr] (wv:/80_forum@imps.com) stored in Step S405, wherein if it is not coincident, the Invite-Request transfer process is finished, and if it is coincident, the process advances to Step S411. Thus, in Step S409, it is determined whether the deleted group is registered in the information table of the client terminal 102.

In Step S411, the client terminal 102 extracts the information (wv:jiro@pqr.com) not coincident with the user information and the Group information included in the character string in the tag <Recipient> in the character string [str_data] from [Recipient] in the information table, which is established as a set along with the Group ID (wv:/80_forum@imps.com) coincident with the retrieval result group ID in Step S409, and stores the same in the character string [str_recip]. Thus, in Step S411, the client terminal 102 extracts the user information and Group information ((wv:jiro@pqr.com)), which are to be indicated in the tag <Recipient> of the Invite-Request 231 transmitted from the client terminal 102 to the IMPS server 114 and are to be added to the tag <Recipient> in the tag <InviteNote> of the Invite-Request 231. Also, in Step S411, unless any of the User information or Group information can be extracted, the client terminal 102 finishes the Invite-Request transfer process.

In Step 412, the client terminal 102 adds a character string [str_recip] (wv:jiro@pqr.com) to the end of the character string in the tag <Recipient> in the character string [str_data] and decreases the value in the tag <Hop> in the character string [str_data] by 1 (that is, decrement by 1). The client terminal 102 encodes the character string [str_data] thus altered, and stores the encoded character string in the character string (str_note_next). Next, in Step S413, the client terminal 102 sets a character string [str_recip] (wv:jiro@pqr.com) in the tag <Recipient> of the Invite-Request 231 transmitted to the IMPS server 114, sets a character string [str_note_next] in the tag <InviteNote> of the Invite-Request 231, and sets the Group ID (wv:80/partygroup@there.com), which is the same as the InviteUser-Request 223, in the tag <GroupID> of the Invite-Request 231.

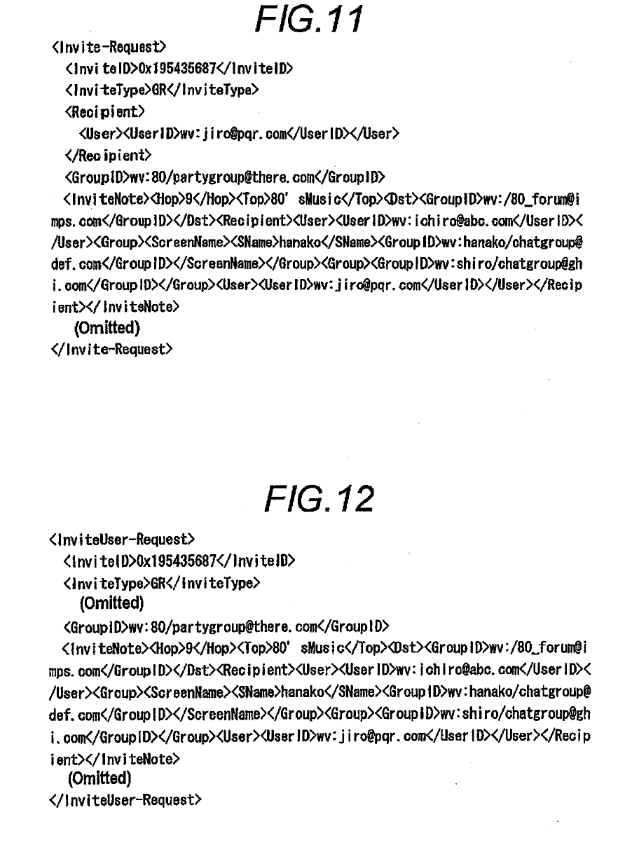

Next, in Step S414, the client terminal 102 transmits the Invite-Request 231 generated in Steps S412 and S413 to the IMPS server 114. FIG. 11 shows XML data of the Invite-Request 231. The IMPS server 114 that has received the Invite-Request 231 transmitted from the client terminal 102 transmits a Status 232 to the client terminal 102, and transmits an InviteUser-Request to all the client terminals shown by the user information or group information indicated in the tag <Recipient> in the Invite-Request 231.

In the example shown in FIG. 1, an InviteUser-Request 233 is transmitted to the client terminal 105. FIG. 12 shows XML data of the InviteUser-Request 233. The data of the tag <InviteNote> of the InviteUser-Request 233 is the same as the data of the tag <InviteNote> of the Invite-Request 231. If the client terminal 105 receives the InviteUser-Request 233, the above described Invite-Request transfer process is carried out after the Status 234 is transmitted to the IMPS server 114.

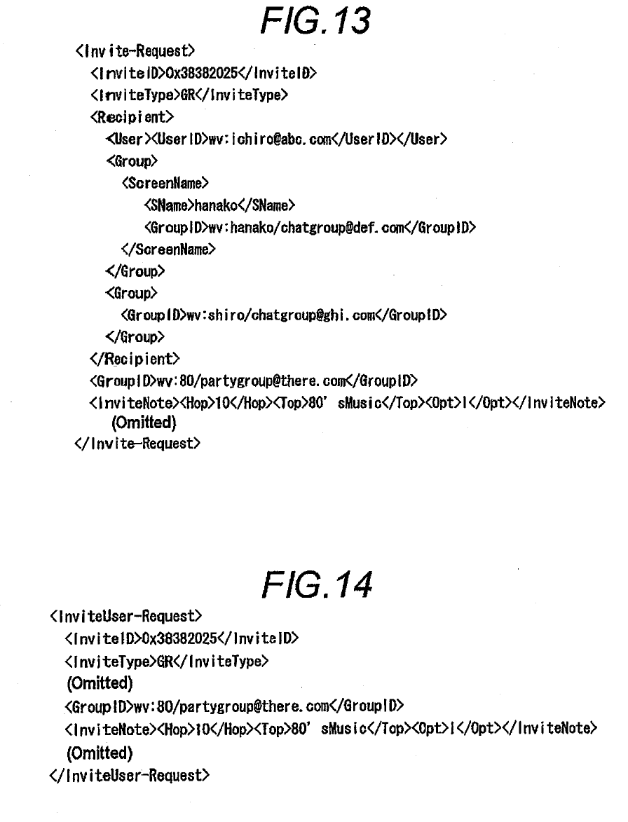

The XML data of the Invite-Request and the InviteUser-Request shown in FIG. 9 through FIG. 12 is data in a case where a part or the entirety of the deleted group 111 (wv:/80_forum@imps.com) is restored. FIG. 13 shows one example of the XML data of the Invite-Request 221 that the client terminal 101 transmits to the IMPS server 114 when a group relating to specified information is newly prepared or extended. Also, where the group is extended, the client terminal 101 does not transmit any CreateGroup-Request 211.

[I] showing the retrieval of groups subjected to partial coincidence is shown in the tag <Opt> in the tag <InviteNote> of the Invite-Request 221 shown in FIG. 13. Also, the tag <Dst> showing the Group ID of the inviting group is not indicated in the tag <InviteNote>. Therefore, the destination of transfer of the Invite-Request 221 is not limited to the users who have participated in a specified group. In addition, in the present embodiment, where the tag <Dst> is not indicated in the tag <InviteNote> since the information in the tag <Dst> shows the group to be restored, the information does not specify restoration of the group but shows an invitation request for the purpose of extending a group of a specified Topic. However, since a flag showing an invitation request for the purpose of extension of groups exists in the received data without limiting to such a mode, such a mode may be accepted in which it is determined that the Invite-Request 221 is an invitation request for the purpose of extension of groups, and the destination of transfer of the Invite-Request 221 is not limited to users who have participated in a specified group.

FIG. 14 shows one example of XML data of the InviteUser-Request 223 that the IMPS server 114 which has received the Invite-Request 221 transmits to the client terminal 102. In the Invite-Request transfer process carried out by the client terminal 102 that has received the InviteUser-Request 223 shown in FIG. 14, since the tag <Dst> does not exist in the tag <InviteNote> of the InviteUser-Request 223, the process advances from Step S408 to S410.

In Step S410, the client terminal 102 extracts information, which is not coincident with the Group ID (wv:80/partygroup@there.com) shown in the tag <GroupID> of the InviteUser-Request 223 and is not coincident with the group information included in the character string in the tag <Recipient> of the character string [str_data] stored in Step S402, from the retrieval result group IDs being the Group ID (wv:/80_forum@imps.com, wv:yumiko/chatgroup@there.com) of the group registered in the information table corresponding to the Topic (80's Music, 80's) that satisfies the condition A or the condition B, and stores the same in the character string [str_recip]. Thus, in Step 8410, the group of Group ID which is not designated in the InviteUser-Request 223 which is at least partially coincident with the Topic is extracted. Therefore, it is possible to extend the group relating to a similar topic. In addition, in Step S410, if any of the group information cannot be extracted, the client terminal 102 finishes the Invite-Request transfer process.

Further, in Step S410, the client terminal 102 extracts information that is not coincident with the user information and group information included in the character string in the tag <Recipient> in the character string [str_data] from the [Recipient] corresponding to the retrieval result group ID not only for the group information but also for the user information, and may store the same in the character string [str_recip]. In this case, if neither of the user information nor the group information can be extracted, the client terminal 102 finishes the Invite-Request transfer process.

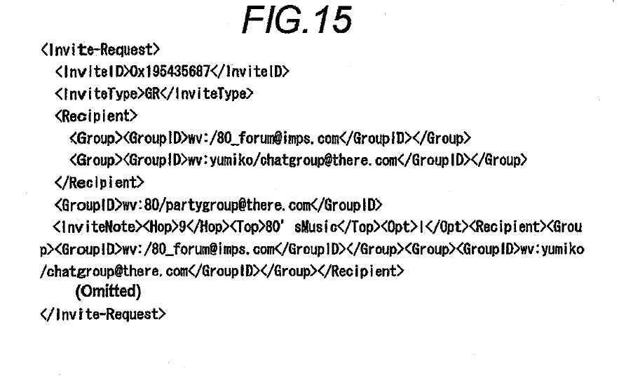

Since the processes coming after Step S410 are the same as those of Steps S412 through S414 described above, the description thereof is omitted. FIG. 15 shows XML data of the Invite-Request 231 passing through Step S410 and generated in Steps S412 and S413. Group IDs [wv:/80forum@imps.com] and [wv:yumiko/chatgroup@there.com] are added in the tag <Recipient> of the Invite-Request 231 shown in FIG. 15, and the tag <Recipient> including Group IDs [wv:/80forum@imps.com] and [wv:yumiko/chatgroup@there.com] is added in the tag <InviteNote>.

As described above, according to the group forming system of the present embodiment, when a deleted group is restored, the tag <Invite-Note> of the Invite-Request that a client terminal transmits to the IMPS server 114 includes the Group ID and Topic of a group to be restored, and identification information of users or groups that have been invited to the group by the client terminal. Also, the IMPS server 114 that has received the Invite-Request transmits the InviteUser-Request including the tag <InviteNote>, which is the same as the tag <InviteNote> of the Invite-Request, to other client terminals. The client terminal that has received the InviteUser-Request transmits the Invite-Request including data existing in the tag <InviteNote> of the InviteUser-Request in the tag <InviteNote> to the IMPS server 114. Thus, the Invite-Request including the tag <InviteNote> is transmitted to the client terminal of a user or a group, which has been invited to the group to be restored, via the IMPS server 114 in the form of InviteUser-Request, and the respective client terminals may obtain information relating to the user of the group to be restored, and the group thereof.

Further, the respective client terminals that have received the InviteUser-Request additionally write information relating to the user or group, which has been invited to the group to be restored, in the tag <InviteNote> with reference to the InviteUser-Request and information table, and transmits the Invite-Request including the tag <InviteNote> to the IMPS server 114. Thus, by additionally writing the information relating to the user or group to the tag <InviteNote>, it is possible to prevent a plurality of InviteUser Requests from being transmitted to a single client terminal.

Still further, since the value showing the number of transferable times is shown in the tag <Hop> in the tag <InviteNote> of the Invite-Request, and the number of transferable times is decremented one by one whenever the client terminal transmits the Invite-Request, it is possible to limit the number of transfers of Invite-Request within a fixed number of times. By limiting the transfers of the Invite-Request within a fixed number of times, it is possible to prevent the Invite-Request from being endlessly transferred.

In addition, according to the group forming system of the present embodiment, when newly preparing or extending a group, the tag <InviteNote> of the Invite-Request that the client terminal transmits to the IMPS server 114 includes a Topic, which a user of the client terminal desires, and a tag <Opt> showing a retrieval of a group by partial coincidence (I), but does not include the tag <Dst>. Also, the IMPS server 114 that has received the Invite-Request transmits an InviteUser-Request including the tag <InviteNote>, which is the same as the tag <InviteNote> of the Invite-Request, to the client terminal. The client terminal that has received the InviteUser-Request extracts a group, which is at least partially coincident with the Topic indicated in the tag <InviteNote> of the InviteUser-Request, from the information table that stores the groups which the client terminal has invited, and the client terminal transmits the Invite-Request including the Group ID of the extracted group to the IMPS server 114. Therefore, the group related to the Topic that the user desires can be extended.

Also, the client terminal that has received an InviteUser-Request transmits the Invite-Request including the tag <InviteNote>, in which information relating to the extracted group or the user is additionally written, to the IMPS server 114. Thus, by additionally writing the information relating to the group or user in the tag <InviteNote>, it is possible to prevent a plurality of InviteUser-Requests from being transmitted to a single client terminal.

Further, as in restoring the group, since the value showing the number of transferable times is shown in the tag <Hop> in the tag <InviteNote> of the Invite-Request, and the number of transferable times is decremented one by one whenever the client terminal transmits the Invite-Request, it is possible to limit the number of transfers of Invite-Request within a fixed number of times. By limiting the transfers of the Invite-Request within a fixed number of times, it is possible to prevent the Invite-Request from being endlessly transferred.

Also, the Topic may not be indicated in the tag <InviteNote> of the Invite-Request, and the client terminal that has received the InviteUser-Request may obtain Topic by requesting a property of the inviting group to the IMPS server 114. Therefore, instead of increasing the processes of request and response such as GetGroupProps-Request and GetGroupProps-Response, there is no case where even if the Topic information is huge, the transmission data size is excessive to cause the Topic information to be lost. In addition, if information necessary to transfer the Invite-Request is included in the Invite-Request and the client terminal has the above-described information table, it is possible to restore the group without adding other functions to the IMPS server 114. Furthermore, by including information necessary to transfer the Invite-Request in the existing tag such as the tag <InviteNote> of the Invite-Request, the group can be restored without adding any other functions to the IMPS server 114 even if the IMPS server 114 is brought into specification capable of detecting an error without ignoring any tag not being in the specification.

### Second Embodiment

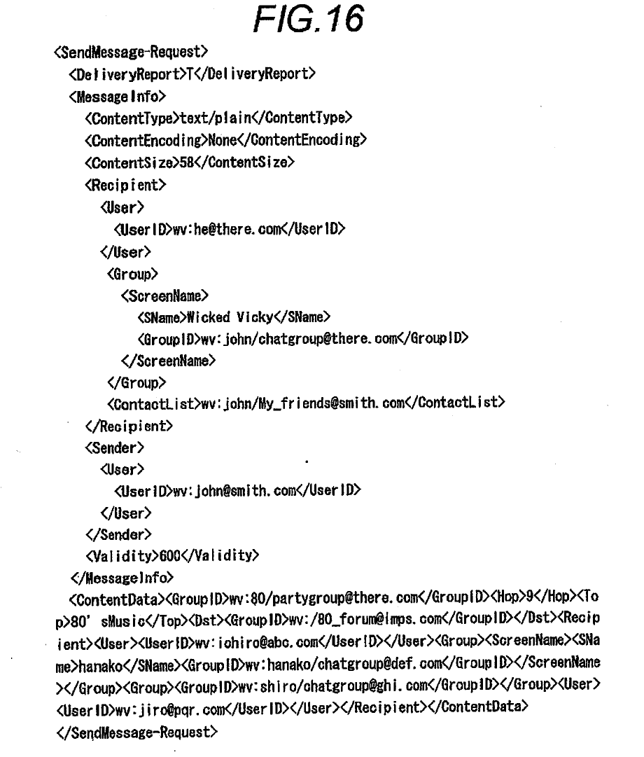

In the first embodiment, although the client terminal transmits an Invite-Request to the IMPS server 114, the client terminal may transmit a SendMessage-Request including the information shown by the corresponding invite-Request. FIG. 16 shows XML data of a SendMessage-Request that the client terminal 102 transmits to the IMPS server 114 in the group forming system shown in FIG. 1. As shown in FIG. 16, the tag <ContentData> of the SendMessage-Request includes the group information (wv:80/partygroup@there.com) in the tag <GroupID> of the Invite-Request 231 and the information in the tag <InviteNote>.

As in the present embodiment, if a SendMessage-Request in which an invitation request to a group is stored is transmitted, the transfer data will be hardly lost where the system is below general data size restriction, that is, where the data quantity placed in an invitation request is smaller than the data quantity placed in a message.

According to the group forming system of the embodiments described above, even if a group, which is freely prepared or deleted by an intention of a certain user, of open groups or private groups, etc., in the IMPS system is deleted, a part or the entirety of the deleted group can be restored, or a group relating to specified information can be newly prepared or extended easily. In addition, the group can be restored by members limited to users who belonged to the deleted group or reliable users. Further, since the IMPS server 114 only receives the Invite-Request and only transmits the InviteUser-Request to the client terminal, the IMPS server 114 is not subjected to any load required for retrieval of users and groups.

Although the present invention was described in detail or with reference to specified embodiments, it is obvious by one skilled in the art that the invention may be subjected to various variations and modifications without departing from the spirit and scope of the present invention.

### INDUSTRIAL APPLICABILITY

A group forming system according to the present invention is practical as an IMPS system capable of restoring a deleted group and easily carrying out formation of a group such as new preparation and extension of groups.

1. A group forming system for forming a group of at least a part of a plurality of client terminals which carry out communications via a network, wherein:
each of the client terminals stores a history of users or groups of other client terminals invited to a predetermined group, and the history has, group by group, identification information of the predetermined group, topic information of the predetermined group and identification information of the users or groups invited to the predetermined group so as to be associated with each other;
a first client terminal of a user that desires restoration of a deleted group when restoring at least a part of the deleted group transmits an invitation request including topic information of the deleted group and identification information of the deleted group to the client terminals of users or groups invited to the deleted group by the first client terminal; and
in a case where the same topic information as the topic information indicated in the invitation request is included, and a corresponding group of the same identification information as the identification information of the group indicated in the invitation request is included, in the history stored in a second client terminal that has received the invitation request, the second client terminal transmits the invitation request to users or groups, which are not included in the users or groups which the first client terminal has invited, among users or groups invited by the second client terminal to the corresponding group.

2. The group forming system according to claim 1, wherein the invitation request includes identification information of the users or groups invited by the first client terminal to the deleted group.

3. The group forming system according to claim 2, wherein the second client terminal adds identification information of the users or groups, which are not included in the users or groups indicated in the invitation request transmitted by the first client terminal, among the users or groups invited by the second client terminal to the corresponding group, to the identification information of users or groups indicated in the invitation request which is to be transmitted by the second client terminal.

4. The group forming system according to claim 1, wherein the invitation request includes a value showing the number of transferable times of the invitation request transmitted between the client terminals, and the respective client terminals decrement the value one by one whenever the invitation request is transmitted to other client terminals.

5. The group forming system according to claim 1, wherein the invitation request includes information to instruct to retrieve whether the history stored in the client terminal which has received the invitation request includes the same topic information as the topic information indicated in the invitation request.

6. The group forming system according to claim 1, wherein the client terminal transmits the information included in the invitation request in the form of a message.

7. A group forming system for forming a group of at least a part of a plurality of client terminals which carry out communications via a network, wherein:
each of the client terminals stores a history of users or groups of other client terminals invited to a predetermined group, and the history has, group by group, identification information of the predetermined group, topic information of the predetermined group and identification information of the users or groups invited to the predetermined group so as to be associated with each other;
when extending a group related to specified information, a first client terminal of a user that desires extension of the group transmits an invitation request including topic information relating to the specified information and identification information of the group to be extended to client terminals of users or groups included in the history stored in the first client terminal and corresponding to the specified topic; and
in a case where corresponding topic information at least partially including the topic information indicated in the invitation request is included in the history stored in a second client terminal that has received the invitation request, the second client terminal transmits the invitation request to corresponding groups excluding the groups having the same identification information as the identification information of the group to be extended indicated in the invitation request among the groups corresponding to the corresponding topic information, the corresponding group not included in the groups which the first client terminal has invited.

8. The group forming system according to claim 7, wherein the invitation request includes identification information of users or groups invited to the group corresponding to the topic information.

9. The group forming system according to claim 7, wherein the second client terminal adds identification information of the corresponding group to the invitation request to be transmitted by the second client terminal.

10. The group forming system according to claim 7, wherein the invitation request has a value showing the number of transferable times of the invitation request transmitted between the client terminals, and
the respective client terminals decrement the value one by one whenever the invitation request is transmitted to other client terminals.

11. The group forming system according to claim 7, wherein the invitation request includes information to instruct to retrieve for whether the corresponding topic information at least partially including the topic information indicated in the invitation request, in the history stored in the client terminal that has received the invitation request.

12. The group forming system according to claim 7, wherein the client terminal transmits the information indicated in the invitation request in the form of a message.

13. A group forming system for forming a group of at least a part of a plurality of client terminals which carry out communications via a network, wherein:
each of the client terminals stores a history of users or groups of other client terminals invited to a predetermined group, and the history has, group by group, identification information of the predetermined group, topic information of the predetermined group and identification information of the users or groups invited to the predetermined group so as to be associated with each other;
when newly preparing a group related to specified information, a first client terminal of a user that desires new preparation of the group transmits an invitation request including topic information relating to the specified information and identification information of the newly preparing group to client terminals of users or groups included in the history stored in the first client terminal and corresponding to the specified topic; and
in a case where corresponding topic information at least partially including the topic information indicated in the invitation request is included in the history stored in a second client terminal that has received the invitation request, the second client terminal transmits the invitation request to corresponding user of corresponding groups excluding the groups having the same identification information as the identification information of the newly preparing group indicated in the invitation request among the groups corresponding to the corresponding topic information, the corresponding group not included in the groups which the first client terminal has invited.

14. A client terminal used in a group forming system for forming a group of at least a part of a plurality of client terminals which carry out communications via a network, wherein:
the client terminal stores a history of users or groups of other client terminals invited to a predetermined group, and the history has, group by group, identification information of the predetermined group, topic information of the predetermined group and identification information of the users and groups invited to the predetermined group so as to be associated with each other;
when restoring at least a part of a deleted group, the client terminal transmits an invitation request including topic information of the deleted group and identification information of the deleted group to client terminals of users or groups invited to the deleted group; and
when the client terminal receives an invitation request from another client terminal, in a case where the history includes the same topic information as the topic information indicated in the invitation request and a corresponding group of the same identification information as the identification information of the group indicated in the invitation request, the client terminal transmits the invitation request to client terminals of users or groups, which are not included in the users or groups which the another client terminal has invited, among the users or groups invited to the corresponding group by the client terminal.

15. The client terminal according to claim 14, wherein the invitation request includes identification information of the users or groups invited by the client terminal to the deleted group.

16. The client terminal according to claim 14, wherein the client terminal adds identification information of a user or a group, which is not included in the users or groups indicated in the invitation request transmitted by the other client terminal, among users or groups invited to the corresponding group, to the identification information of users or groups indicated in the invitation request which is to be transmitted by the client terminal.

17. The client terminal according to claim 14, wherein the invitation request includes a value showing the number of transferable times of the invitation request transmitted between the client terminals, and the client terminal decrement the value one by one whenever the invitation request is transmitted to other client terminals.

18. The client terminal according to claim 14, wherein the invitation request includes information to instruct to retrieve for whether the history stored in the client terminal which has received the invitation request includes the same topic information as the topic information indicated in the invitation request.

19. The client terminal according to claim 14, wherein the client terminal transmits the information included in the invitation request in the form of a message.

20. A client terminal used in a group forming system for forming a group of at least a part of a plurality of client terminals which carry out communications via a network, wherein:
the client terminal stores a history of users or groups of other client terminals invited to a predetermined group, and the history has, group by group, identification information of the predetermined group, topic information of the predetermined group and identification information of the users and groups invited to the predetermined group so as to be associated with each other;
when extending a group related to specified information, the client terminal transmits an invitation request including topic information relating to the specified information and identification information of a group to be extended to client terminals of users or groups included in the history stored in the client terminal and corresponding to the specified topic; and
when receiving an invitation request from another client terminal, in a case where corresponding topic information at least partially including the topic information indicated in the invitation request is included in the history, the client terminal transmits the invitation request to corresponding groups excluding the groups having the same identification information as the identification information of the group to be extended indicated in the invitation request in the groups corresponding to the corresponding topic information, the corresponding group not included in the groups which the another client terminal has invited.

21. The client terminal according to claim 20, wherein the invitation request includes identification information of users or groups invited to the group corresponding to the topic information.

22. The client terminal according to claim 20, wherein the client terminal adds identification information of the corresponding group to the invitation request to be transmitted by the client terminal.

23. The client terminal according to claim 20, wherein the invitation request has a value showing the number of transferable times of the invitation request transmitted between the client terminals; and
the client terminal decrements the value one by one whenever the client terminal transmits the invitation request to the other client terminals.

24. The client terminal according to claim 20, wherein the invitation request includes information to instruct to retrieve for whether the topic information at least partially having the topic information indicated in the invitation request is included in the history stored in the client terminal that has received the invitation request.

25. The client terminal according to claim 20, wherein the client terminal transmits the information included in the invitation request in the form of a message.

26. A client terminal used in a group forming system for forming a group of at least a part of a plurality of client terminals which carry out communications via a network, wherein:
the client terminal stores a history of users or groups of other client terminals invited to a predetermined group, and the history has, group by group, identification information of the predetermined group, topic information of the predetermined group and identification information of users and groups invited to the predetermined group so as to be associated with each other;
when newly preparing a group related to specified information, the client terminal transmits an invitation request including topic information relating to the specified information and identification information of the newly prepared group to client terminals of users or groups included in the history stored in the client terminal and corresponding to the specified topic; and
when receiving an invitation request from another client terminal, in a case where corresponding topic information at least partially including the topic information indicated in the invitation request is included in the history, the client terminal transmits the invitation request to corresponding user of corresponding groups excluding the groups having the same identification information as the identification information of the newly preparing group indicated in the invitation request among the groups corresponding to the corresponding topic information, the corresponding group not included in the groups which the another client terminal has invited.
